(19) United States
(12) Patent Application Publication
(10) Pub. No.: US 2006/0050859 A1
(43) Pub. Date: Mar. 9, 2006

(54) Telephone system, server apparatus, information display method for use therewith and its program

(75) Inventor: Kiyokazu Ootsuka, Tokyo (JP)

Correspondence Address: MICHAEL BEST & FRIEDRICH LLC, 401 NORTH MICHIGAN AVENUE, SUITE 1900, CHICAGO, IL, 60611-4212, US

(73) Assignee: NEC Corporation, Tokyo (JP)

(21) Appl. No.: 11/216,713

(22) Filed: Aug. 31, 2005

(30) Foreign Application Priority Data
Sep. 8, 2004 (JP) 260394/2004

(51) Int. Cl. H04M 11/00; H04M 15/06

(52) U.S. Cl. 379/142.01; 379/93.12

(57) ABSTRACT

The present invention provides a telephone system that can dynamically combine and display various kinds of information at the time of a telephone call incoming. A multifunction telephone receiving an incoming call sends a request message including the sender number and the self-machine number to an HTTP server. The HTTP server receives the request message, and then requests the business card image and various kinds of associated information from a business card information database. The business card information database retrieves the stored information by the sender number, and returns the image information of a found business card as a result of retrieval and the associated customer information to the HTTP server. The HTTP server reconfigured the business card image into the format in which the received customer information is overwritten on the business card image, converts the image into XML data, and returns it. A multifunction telephone displays various kinds of information as the image on an LCD, based on the XML data.

This application claims priority of Japanese Patent Application No. 2004/260394, filed on Sep. 8, 2004.

### BACKGROUND OF THE INVENTION

1. Field of the Invention

The present invention relates to a telephone system, a server apparatus, an information display method for use therewith, and its program, and more particularly to a pop-up display method for making the pop-up display of various kinds of data when there is a telephone call incoming.

2. Description of the Prior Art

Conventionally, when there is a call incoming in the telephone set, an image of the sender corresponding to the sender's number is pop-up displayed on the telephone set or PC (personal computer).

For example, an information display apparatus having speech communication portion has an information display method for displaying the information of mail data or Internet data of the sender when there is a speech incoming, employing the existent Internet or electronic mail system (e.g., refer to Japanese Patent Application Laid-open No. 2001-292226).

In the information display apparatus, data retrieval portion retrieves a sender database based on the sender number acquired by sender number acquisition portion, and application selection portion acquires a resource described in the sender data, employing terminal resource acquisition portion or network resource acquisition portion, based on the retrieved sender data, then selects an application corresponding to the resource and displays the selected resource on display portion by the selected application.

### BRIEF SUMMARY OF THE INVENTION

However, with the conventional information display method for displaying image data on the telephone set, when there is a telephone call incoming, the image information is pop-up displayed on the display screen, but there is a problem that various kinds of information can not be dynamically combined and displayed.

Thus, it is an object of the invention to solve the above-mentioned problem, and to provide a telephone system, a server apparatus, an information display method for use therewith, and its program in which various kinds of information can be dynamically combined and displayed at the time of a telephone call incoming.

The present invention provides a telephone system comprising a telephone set and a server apparatus for providing various kinds of information to the telephone set, the server apparatus comprising means for reconfiguring the image information and its associated information to be provided to the telephone set where there is a telephone call incoming into one image data, and means for returning the reconfigured image data to the telephone set where there is the telephone call incoming.

The invention provides a server apparatus for providing various kinds of information to a telephone set, the server apparatus comprising means for reconfiguring the image information and its associated information to be provided to the telephone set where there is a telephone call incoming into one image data, and means for returning the reconfigured image data to the telephone set where there is the telephone call incoming.

The invention provides an information display method for use in a telephone system comprising a telephone set and a server apparatus for providing various kinds of information to the telephone set, the method displaying information on the telephone set, the method comprising, on the side of the server apparatus, a step of reconfiguring the image information and its associated information to be provided to the telephone set where there is a telephone call incoming into one image data, and a step of returning the reconfigured image data to the telephone set where there is the telephone call incoming.

The invention provides a program for implementing an information display method for use in a telephone system comprising a telephone set and a server apparatus for providing various kinds of information to the telephone set, the method displaying information on the telephone set, the program enabling a computer on the side of the server apparatus to perform a process of reconfiguring the image information and its associated information to be provided to the telephone set where there is a telephone call incoming into one image data, and a process of returning the reconfigured image data to the telephone set where there is the telephone call incoming.

That is, the telephone system of the invention is a multifunction telephone of an IP (Internet Protocol) method having a function of transmitting or receiving the XML (extensible Mark-up Language) data to or from the server apparatus and a large screen LCD (Liquid Crystal Display), in which an image file of business card on the database and the other associated data are displayed on the large screen LCD by an application on the server apparatus in such a manner as to dynamically combine the image of business card corresponding to the sender number and the associated information at the time of a telephone call incoming.

Also, the telephone system of the invention comprises, on the server apparatus, means for retrieving the image of business card corresponding to the sender number where there is a telephone call incoming from means storing the image of business card and various kinds of information, and overwrite means for overwriting various kinds of information on the image of business card resulted from retrieval, in which the image of business card on which various kinds of information is overwritten is displayed on the multifunction telephone.

Thereby, in the telephone system of the invention, the pop-up display at the time of a call incoming is enabled without employing the personal computer, but only by using the multifunction telephone to perform the service.

Also, in the telephone system of the invention, the image of business card can be pop-up displayed on the large screen LCD of the multifunction telephone at the time of a telephone call incoming, whereby it is possible to easily recognize the sender before responding to the call incoming.

Moreover, in the telephone system of the invention, the latest information recorded in the information database of business card is synthesized with the image of business card and displayed on the multifunction telephone, whereby the information of the sender can be dynamically displayed on the multifunction telephone where there is a call incoming.

The invention with the following constitution and operation has the effect that various kinds of information can be dynamically combined and displayed at the time of a telephone call incoming.

### BRIEF DESCRIPTION OF THE DRAWINGS

FIG. 1 is a block diagram showing the configuration of a telephone system in the best mode for carrying out the invention;

FIG. 2 is a block diagram showing the configuration of the first example of an HTTP server according to the invention;

FIG. 3 is a block diagram showing the configuration of the first example of a multifunction telephone according to the invention;

FIG. 4 is a sequence chart showing the operation of the first example of an information display method for the telephone system according to the invention;

FIG. 5 is a block diagram showing the configuration of the second example of a telephone system according to the invention;

FIG. 6 is a block diagram showing the configuration of the second example of an HTTP server according to the invention; and

FIG. 7 is a sequence chart showing the operation of the second example of an information display method for the telephone system according to the invention.

### DETAILED DESCRIPTION OF THE PREFERRED EMBODIMENTS

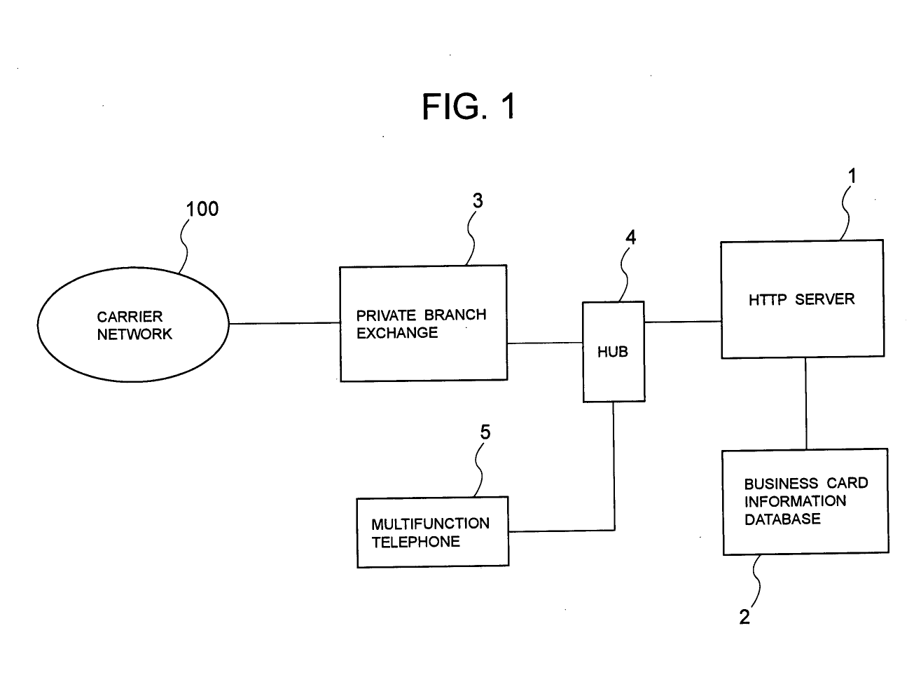

The preferred embodiments of the present invention will be described below with reference to the drawings. FIG. 1 is a block diagram showing the configuration of a telephone system in the best mode for carrying out the invention. In FIG. 1, the telephone system of the invention comprises an HTTP (Hyper Text Transfer Protocol) server 1, a business card information database 2, a private branch exchange 3, a hub 4, a multifunction telephone 5, and a carrier network 100.

First of all, a connecting call from a sender is transferred across the carrier network 100 to the private branch exchange 3, and from the private branch exchange 3 via the hub 4 to the multifunction telephone 5. The multifunction telephone 5 receiving an incoming call sends a request message including the sender number and the self-machine number to the HTTP server 1, and requests an XML page from the HTTP server 1 by designating a URL (Uniform Resource Locator).

The HTTP server 1 receives the request message from the multifunction telephone 5, and then requests the business card image and its various kinds of associated information from the business card information database 2. In this case, the HTTP server 1 makes a database retrieval request to the business card information database 2 by designating the sender number in the request message. The business card information database 2 makes the retrieval for the stored information with the sender number, and as a result of the retrieval, the image information of a found business card and the associated customer information are returned to the HTTP server 1.

If the HTTP server 1 receives the image information of the business card and the associated customer information from the business card information database 2, it then reconfigures the business card image into the format in which the customer information received from the business card information database 2 is overwritten on the business card image, converts the image into XML data, and returns it as a response to the request from the multifunction telephone 5. The multifunction telephone 5 receives the XML data from the HTTP server 1, and then displays various kinds of information as the image on the LCD based on the XML data.

Accordingly, in an embodiment of the invention, the personal computer is not employed to pop-up display the call incoming, but the multifunction telephone 5 is only employed to make the service, whereby the cost is greatly reduced.

Also, in the embodiment of the invention, since the business card image is popped up on the LCD of the multifunction telephone 5 at the time of a telephone call incoming, it is possible to easily recognize the sender before responding to the incoming call.

Further, in the embodiment of the invention, the latest information recorded in the business card information database 2 is synthesized with the business card image and displayed on the multifunction telephone 5, whereby the multifunction telephone 5 receiving the incoming call can dynamically display the information of the sender.

### EXAMPLE 1

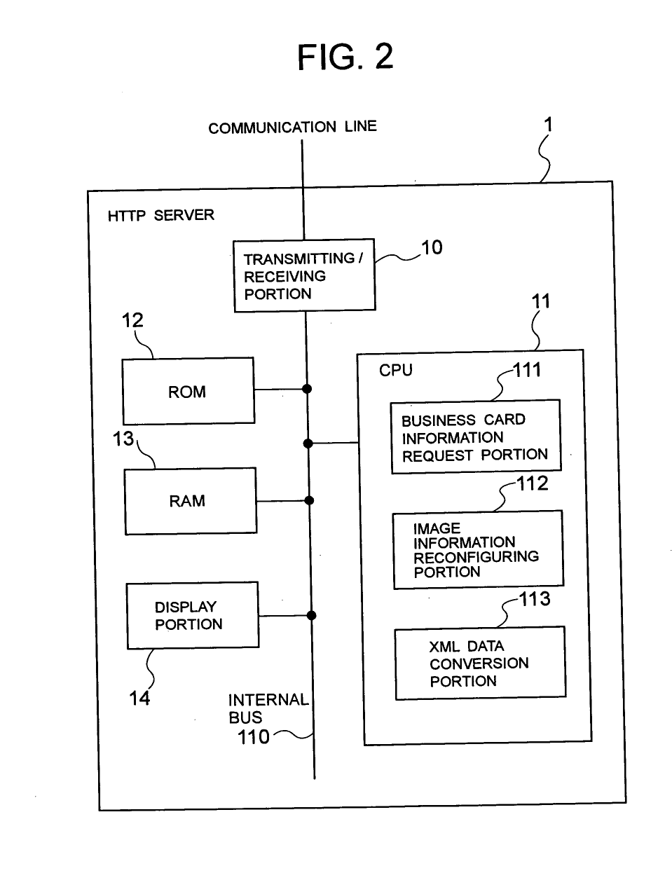

FIG. 2 is a block diagram showing the configuration of the first example of an HTTP server according to the invention. In FIG. 2, the HTTP server 1 comprises transmitting/receiving portion 10, a CPU (Central Processing Unit) 11, a ROM (Read Only Memory) 12, a RAM (Random Access Memory) 13, and a display portion 14, which are interconnected via an internal bus 110 each other. The CPU 11 comprises a business card information request portion 111, an image information reconfiguring portion 112, and an XML data conversion portion 113.

The first example of a telephone system according to the invention has the same configuration as the telephone system according to the invention as shown in FIG. 1, and comprises a carrier network 100, a private branch exchange 3, a hub 4, an HTTP server 1, a business card information database 2 and a multifunction telephone 5.

In the HTTP server 1, the business card information request portion 111 creates a request message for requesting the business card information from the business card information database 2, based on an XML page request sent from the multifunction telephone 5.

The image information reconfiguring portion 112 reconfigures the image information to be displayed on the multifunction telephone 5 from the business card image and various kinds of information received from the business card information database 2. The XML data conversion portion 113 converts the image information reconfigured by the image information reconfiguring portion 112 into the XML data. The transmitting/receiving portion 10 returns the XML data converted by the XML data conversion portion 113 as a response to the request from the multifunction telephone 5.

Each of the above portions of the CPU 11 is implemented by the CPU 11 expanding a program within the ROM 12 over the RAM 13 and executing it. Also, the XML data converted by the XML data conversion portion 113 is displayed on the display portion 14 to allow the operator to check it.

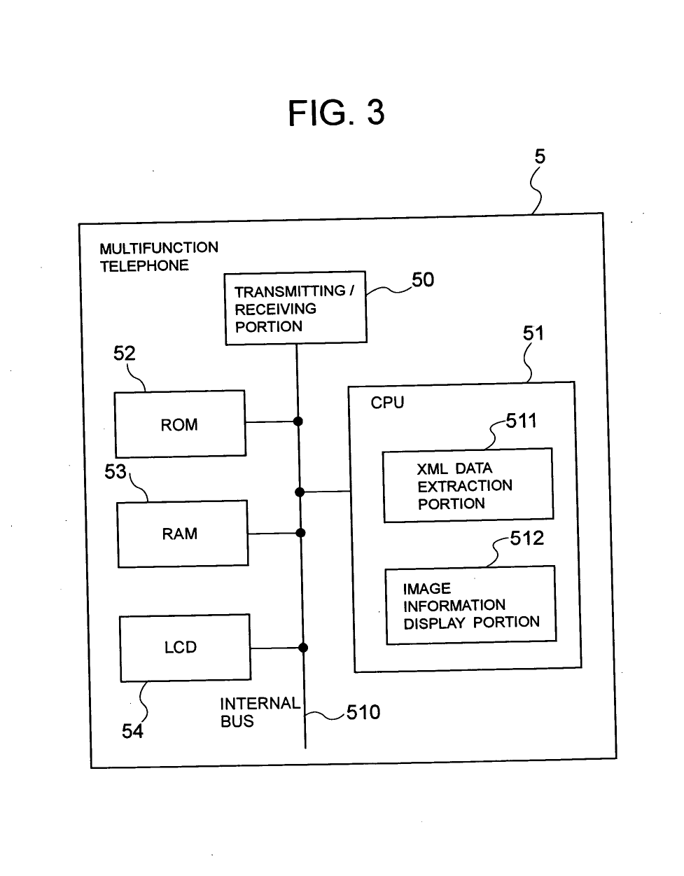

FIG. 3 is a block diagram showing the configuration of the first example of the multifunction telephone according to the invention. In FIG. 3, the multifunction telephone 5 comprises a transmitting/receiving portion 50, a CPU 51, a ROM 52, a RAM 53, and an LCD 54, which are interconnected via an internal bus 510 each other. The CPU 51 comprises an XML data extraction portion 511 and an image information display portion 512.

In the multifunction telephone 5, the XML data extraction portion 511 extracts the XML data of the HTTP server 1 from the data received via the hub 4, and the image information display portion 512 displays the image information on the LCD 54 in accordance with the XML data. Each of the above portions of the CPU 51 is implemented by the CPU 51 expanding a program within the ROM 52 over the RAM 53 and executing it.

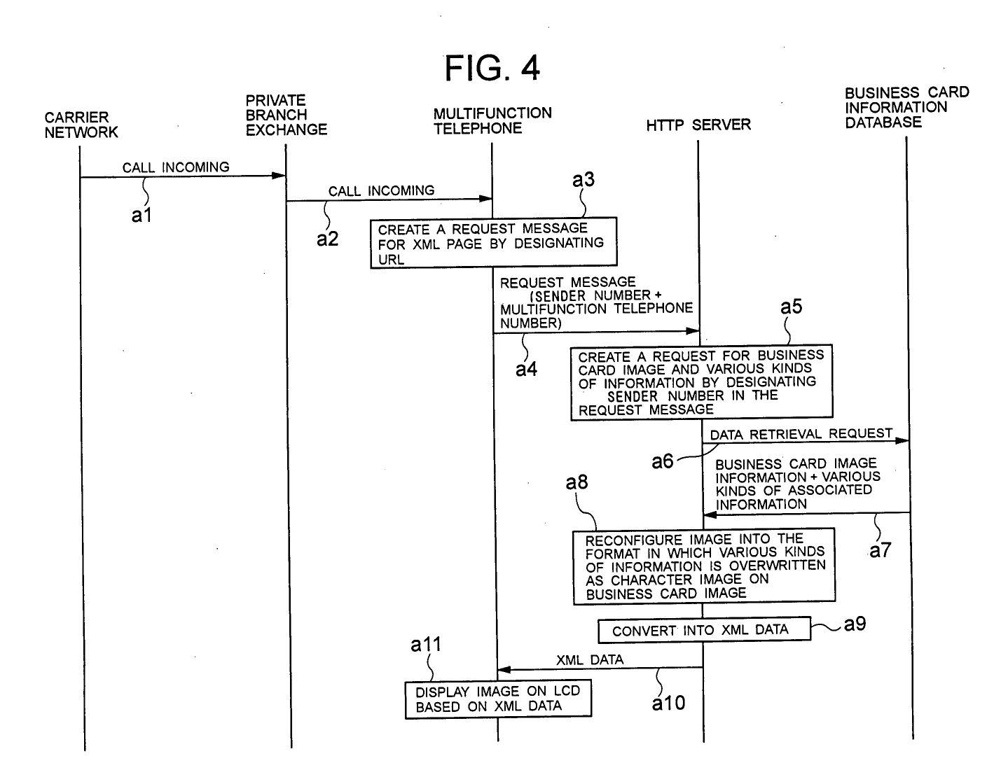

FIG. 4 is a sequence chart showing the operation of the first example of an information display method for the telephone system according to the invention. Referring to FIGS. 1 to 4, the operation of the first example of the information display method for the telephone system according to the invention will be described below. The processes of the HTTP server 1 and the multifunction telephone 5 in FIG. 4 are implemented by the CPUs 11, 51 executing the programs of the ROMs 12, 52.

First of all, a connecting call from the sender is transferred over the carrier network 100 to the private branch exchange 3 (a1 of FIG. 4), and from the private branch exchange 3 to the multifunction telephone 5 (a2 of FIG. 4). The multifunction telephone 5 receiving an incoming call sends a request message including the sender number and the self-machine number (number of the multifunction telephone 5) to the HTTP server 1, and requests an XML page from the HTTP server 1 by designating a URL (a3, a4 of FIG. 4).

The HTTP server 1 receives the request message from the multifunction telephone 5, and then requests the business card image and its various kinds of information from the business card information database 2. At this time, the HTTP server 1 makes a data retrieval request to the business card information database 2 by designating the sender number in the request message (a5, a6 of FIG. 4).

The business card information database 2 makes the retrieval for the stored information in accordance with the data retrieval request from the HTTP server 1, and as a result of the retrieval, the image information of a found business card and various kinds of associated information are returned to the HTTP server 1 (a7 of FIG. 4).

If the HTTP server 1 receives the image information of the business card and various kinds of associated information from the business card information database 2, it then reconfigures the business card image into the format in which various kinds of information is overwritten as the character image on the business card image (a8 of FIG. 4), converts the reconfigured image into XML data (a9 of FIG. 4), and returns the XML data as a response to the request from the multifunction telephone 5 (a10 of FIG. 4).

The multifunction telephone 5 receives the XML data from the HTTP server 1, and then displays the image in which various kinds of information is overwritten as the character image on the LCD 54 based on the XML data (a11 of FIG. 4).

In this manner, in this example, since the corresponding business card image is synthesized with various kinds of data acquired from the business card information database 2, and displayed on the multifunction telephone 5, based on the sender number from the sender, making it possible to display the information of the sender before responding to an incoming call at the time of a telephone call incoming, the responder can appropriately deal with the call incoming.

Also, in this example, when making a request for the business card information, access to the business card information database 2 is regulated by transmitting the number of the multifunction telephone 5 making the request to the HTTP server 1.

### EXAMPLE 2

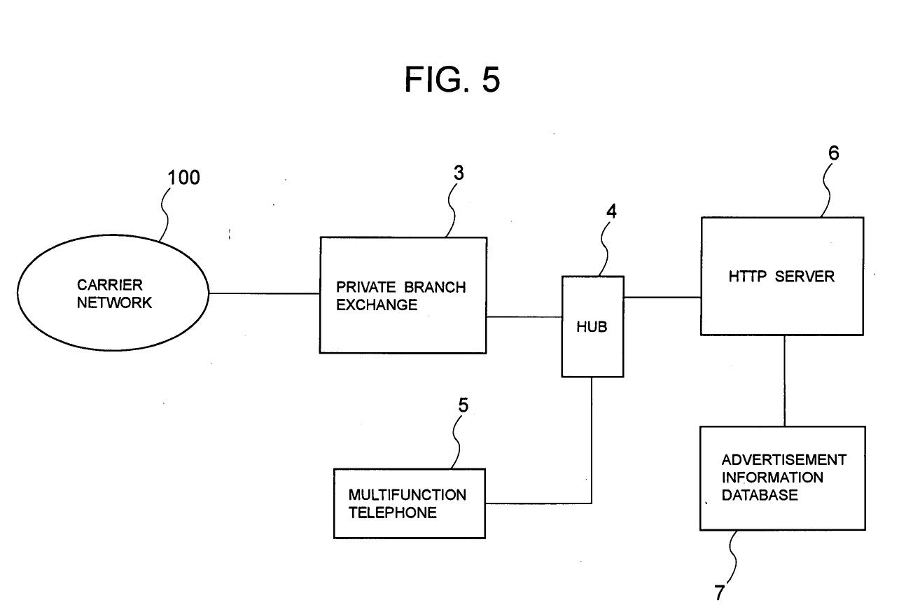

FIG. 5 is a block diagram showing the configuration of the second example of a telephone system according to the invention. In FIG. 5, the second example of the telephone system according to the invention comprises a carrier network 100, a private branch network 3, a hub 4, an HTTP server 6, an advertisement information database 7, and a multifunction telephone 5.

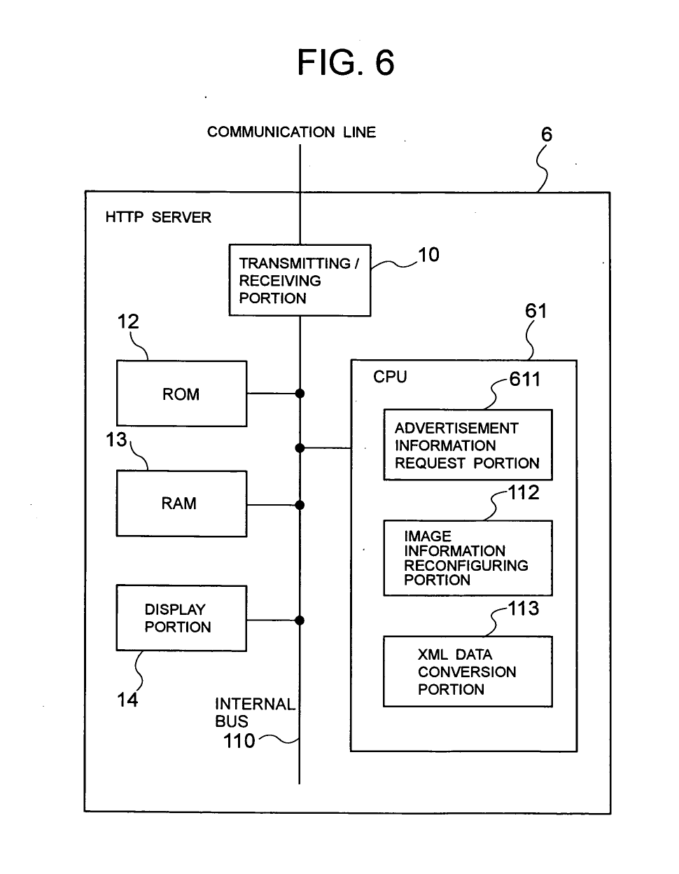

FIG. 6 is a block diagram showing the configuration of the second example of an HTTP server according to the invention. In FIG. 6, the HTTP server 6 comprises transmitting/receiving portion 10, a CPU 61, a ROM 12, a RAM 13, and a display portion 14, which are interconnected via an internal bus 110 each other. The CPU 61 has the same configuration as the CPU 11 as shown in FIG. 2, except that an advertisement information request portion 611 is provided instead of the business card information request portion 111. The same parts are designated by the same numerals. The second example of the multifunction telephone 5 according to the invention has the same configuration as the first example of the multifunction telephone 5 as shown in FIG. 3.

In the HTTP server 6, the advertisement information request portion 611 creates a request message for requesting the advertisement information from the advertisement information database 7, based on an XML page request sent from the multifunction telephone 5.

The image information reconfiguring portion 112 reconfigures the image information to be displayed on the multifunction telephone 5 from the advertisement image and various kinds of information received from the advertisement information database 7. The XML data conversion portion 113 converts the image information reconfigured by the image information reconfiguring portion 112 into the XML data. The transmitting/receiving portion 10 returns the XML data converted by the XML data conversion portion 113 as a response to the request from the multifunction telephone 5.

Each of the above portions of the CPU 61 is implemented by the CPU 61 expanding a program within the ROM 12 over the RAM 13 and executing it. Also, the XML data converted by the XML data conversion portion 113 is displayed on the display portion 14 to allow the operator to check it.

In the multifunction telephone 5, an XML data extraction portion 511 extracts the XML data of the HTTP server 6 from the data received via the hub 4, and the image information display portion 512 displays the image information on the LCD 54 in accordance with the XML data. Each of the above portions of the CPU 51 is implemented by the CPU 51 expanding a program within the ROM 52 over the RAM 53 and executing it.

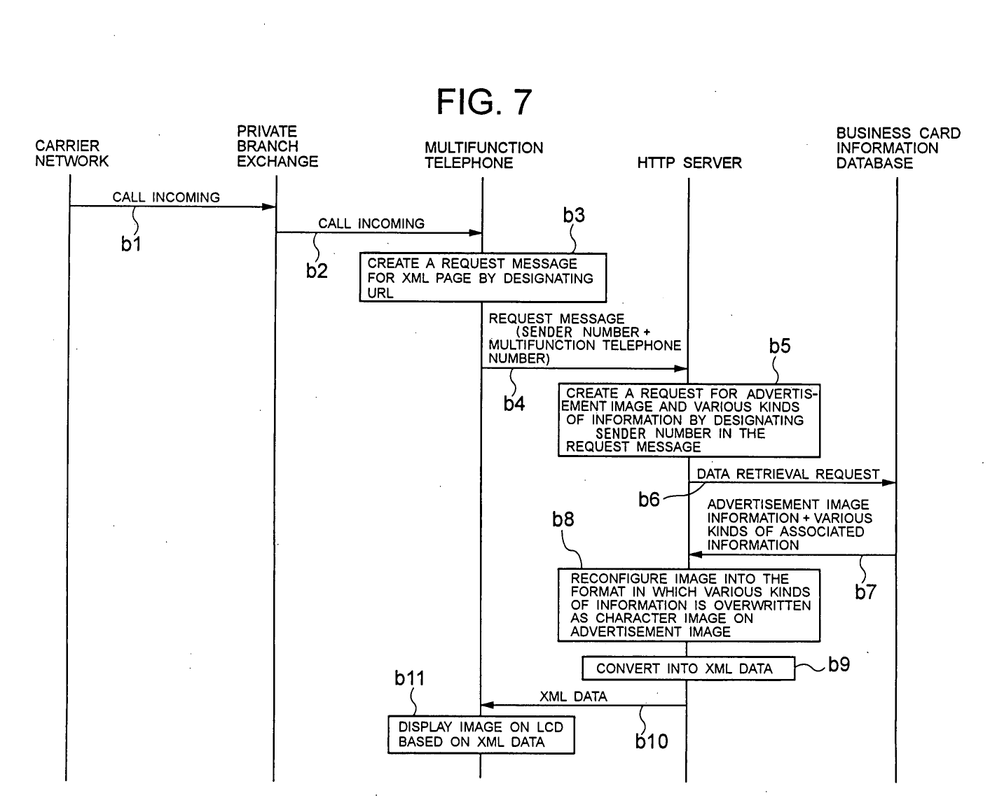

FIG. 7 is a sequence chart showing the operation of the second example of an information display method for the telephone system according to the invention. Referring to FIG. 3 and FIGS. 5 to 7, the operation of the second example of the information display method for the telephone system according to the invention will be described below. The processes of the HTTP server 6 and the multifunction telephone 5 in FIG. 7 are implemented by the CPUs 61, 51 executing the programs of the ROMs 12, 52.

First of all, a connecting call from the sender is transferred over the carrier network 100 to the private branch exchange 3 (bl of FIG. 7), and from the private branch exchange 3 to the multifunction telephone 5 (b2 of FIG. 7). The multifunction telephone 5 receiving an incoming call creates a request message including the sender number and the self-machine number (number of the multifunction telephone 5) to the HTTP server 6 and sends it to request an XML page from the HTTP server 6 by designating a URL (b3, b4 of FIG. 7).

The HTTP server 6 receives the request message from the multifunction telephone 5, and then requests the business card image and various kinds of information from the advertisement information database 7. At this time, the HTTP server 6 makes a data retrieval request to the advertisement information database 7 by designating the sender number in the request message (b5, b6 of FIG. 7).

The advertisement information database 7 makes the retrieval for the stored information in accordance with the data retrieval request from the HTTP server 6, and as a result of the retrieval, the image information of a found business card and various kinds of associated information are returned to the HTTP server 6 (b7 of FIG. 7).

If the HTTP server 6 receives the image information of the business card and various kinds of associated information from the advertisement information database 7, it then reconfigures the business card image into the format in which various kinds of information is overwritten as the character image on the business card image (b8 of FIG. 7), converts the reconfigured image into XML data (b9 of FIG. 7), and returns the XML data as a response to the request from the multifunction telephone 5 (b10 of FIG. 7).

The multifunction telephone 5 receives the XML data from the HTTP server 6, and then displays the image in which various kinds of information is overwritten as the character image on the LCD 54 based on the XML data (b11 of FIG. 7).

In this manner, in this example, since the corresponding advertisement image is synthesized with various kinds of data acquired from the advertisement information database 7, and displayed on the multifunction telephone 5, based on the sender number from the sender, making it possible to display the advertisement before responding to the incoming call at the time of a telephone call incoming, the advertisement information can be presented to the responder.

The invention is applicable to the pop-up of sender information in a typical office, or in a simple contact center.

What is claimed is:

1. A telephone system comprising a telephone set and a server apparatus for providing various kinds of information to said telephone set, said server apparatus comprising:
means for reconfiguring the image information and its associated information to be provided to the telephone set where there is a telephone call incoming into one image data; and
means for returning the reconfigured image data to said telephone set where there is the telephone call incoming.

2. The telephone system according to claim 1, wherein said server apparatus comprises means for converting said reconfigured image data into XML (extensible Mark-up Language) data, and said telephone set displays said image data in accordance with the XML data from said server apparatus.

3. The telephone system according to claim 1, wherein said image information is image information of a business card corresponding to the sender of said telephone call incoming.

4. The telephone system according to claim 1, wherein said image information is image information of an advertisement corresponding to the sender of said telephone call incoming.

5. The telephone system according to claim 1, wherein said server apparatus is an HTTP (Hyper Text Transfer Protocol) server.

6. A server apparatus for providing various kinds of information to a telephone set, said server apparatus comprising:
means for reconfiguring the image information and its associated information to be provided to the telephone set where there is a telephone call incoming into one image data; and
means for returning the reconfigured image data to said telephone set where there is the telephone call incoming.

7. The server apparatus according to claim 6, further comprising means for converting said reconfigured image data into XML data.

8. The server apparatus according to claim 6, wherein said image information is image information of a business card corresponding to the sender of said telephone call incoming.

9. The server apparatus according to claim 6, wherein said image information is image information of an advertisement corresponding to the sender of said telephone call incoming.

10. The server apparatus according to claim 6, wherein said server apparatus is an HTTP server.

11. An information display method for use in a telephone system comprising a telephone set and a server apparatus for providing various kinds of information to said telephone set, said method displaying information on the telephone set, said method comprising, on the side of said server apparatus:
a step of reconfiguring the image information and its associated information to be provided to the telephone set where there is a telephone call incoming into one image data; and
a step of returning the reconfigured image data to said telephone set where there is the telephone call incoming.

12. The information display method according to claim 11, further comprising, on the side of said server apparatus, a step of converting said reconfigured image data into XML data, and said telephone set displays said image data in accordance with the XML data from said server apparatus.

13. The information display method according to claim 11, wherein said image information is image information of a business card corresponding to the sender of said telephone call incoming.

14. The information display method according to claim 11, wherein said image information is image information of an advertisement corresponding to the sender of said telephone call incoming.

15. The information display method according to claim 11, wherein said server apparatus is an HTTP server.

16. A program for implementing an information display method for use in a telephone system comprising a telephone set and a server apparatus for providing various kinds of information to said telephone set, said method displaying information on the telephone set, said program enabling a computer on the side of said server apparatus to perform, said program comprising:
a process of reconfiguring the image information and its associated information to be provided to the telephone set where there is a telephone call incoming into one image data; and
a process of returning the reconfigured image data to said telephone set where there is the telephone call incoming.
